(19) United States
(12) Patent Application Publication
(10) Pub. No.: US 2005/0157146 A1
(43) Pub. Date: Jul. 21, 2005

(54) Ink-jet recording medium and method for production thereof

(75) Inventors: Noboru Kondo, Tokyo (JP); Yoshio Yoshida, Tokyo (JP); Kazuhiro Iwasaki, Tokyo (JP); Shoichi Endo, Tokyo (JP); Tsuyoshi Kobayashi, Tokyo (JP)

Correspondence Address: MILLEN, WHITE, ZELANO & BRANIGAN, P.C., 2200 CLARENDON BLVD., SUITE 1400, ARLINGTON, VA, 22201, US

(73) Assignee: NIPPON PAPER INDUSTRIES CO., LTD., Tokyo (JP)

(21) Appl. No.: 10/507,188

(22) PCT Filed: Mar. 7, 2003
(86) PCT No.: PCT/JP03/02754

(30) Foreign Application Priority Data
Mar. 11, 2002 (JP) 2002-065014

(51) Int. Cl. B41J 2/01

(52) U.S. Cl. 347/105

(57) ABSTRACT

An inkjet recording medium having a gloss comparable to that of a silver halide photograph is disclosed. This inkjet recording medium is prepared by coating a recording layer containing alumina and polyvinyl alcohol on a support having air permeability, applying a treatment solution containing a borate and a water-soluble magnesium salt while the recording layer is still wet, pressing the recording layer in contact with a heated mirror surface while the recording layer is still wet, and drying.

### FIELD OF THE INVENTION

This invention relates to an inkjet recording medium, and more particularly to a high quality inkjet recording medium having a gloss comparable to that of a silver halide photograph, and to its method of manufacture.

### BACKGROUND OF THE INVENTION

In general, in inkjet recording methods, recording is performed by spraying ink droplets from various devices, and the droplets adhere to a recording paper so as to form dots. The advantages of inkjet recording as compared to dot impact printing are that it is noiseless, it is easy to adapt to full color, and high-speed printing can be performed. On the other hand, ink jet recording has the disadvantage that, as the inks used are normally water-based inks consisting of direct dyes or acidic dyes, drying properties are poor.

The properties required of the inkjet recording sheet used in this inkjet recording method are that ink drying speed is rapid, print density is high, there is no ink smudging or blurring, and there is no wave Of the paper due to ink absorption. A method for manufacturing a high-quality inkjet recording paper satisfying these properties has already been disclosed (Tokkai-Sho 62-95285, ibid. 63-264391, Tokkai-Hei 2-274587, ibid. 5-59694).

In all of these manufacturing methods, a recording layer is obtained by coating a pigment having synthetic silica as its principal component together with a binder, and pressing the coated layer, while it is still wet, in contact with a heated mirror surface so as to transfer and simultaneously dry the mirror surface, and thus obtain a high gloss cast-coated paper. However, the gloss of the uppermost layer was still low, and the gloss like a silver halide photograph could not be obtained.

On the other hand, a method of manufacturing an inkjet recording medium having the gloss of a silver halide photograph, wherein a recording layer containing a hydrophilic binder such as polyvinyl alcohol or gelatin and inorganic particulates is coated on a resin-coated paper (“RC paper”) having a polyolefin coating layer to which a white pigment or the like has been added on at least one surface of a base paper, has also been proposed (Tokkai-Hei 10-119423, Tokkai-Hei 11-20306). However, these inkjet recording media use a resin coating paper with no air permeability as a support, so it took time for the medium to dry after coating the recording layer, and productivity was extremely low.

As a result of intensive studies designed to resolve the aforesaid disadvantages, the inventors discovered that an inkjet recording medium having a high strength recording layer with excellent surface gloss could be obtained by coating a recording layer containing polyvinyl alcohol, treating the surface of the recording layer with a solution containing a borate while the recording layer was still wet, pressing the surface of the recording layer in contact with a heated mirror surface while the recording layer was still wet, and drying.

However, it was discovered that if the recording medium obtained as described above was stored for a long period of time between plastic sheets such as those of a clear folder, the white parts turned yellow. As a result of further studies to resolve the aforesaid problem, the inventors discovered that by simultaneously blending a water-soluble magnesium salt in the treatment solution containing the borate, an inkjet recording sheet which did not change to yellow when stored in a folder could be obtained.

It is therefore a first object of this invention to provide an inkjet recording medium having a gloss comparable to that of a silver halide photograph, having a high strength recording layer, and which does not yellow when stored in a folder.

It is a second object of this invention to provide a method of manufacturing a recording medium having a gloss comparable to that of a silver halide photograph, having a high strength recording layer, and which does not yellow when stored in a clear folder.

### DISCLOSURE OF THE INVENTION

The present invention is achieved by an inkjet recording medium characterized that obtained by providing a recording layer comprising alumina and polyvinyl alcohol on a support having air permeability, coating a treatment solution which solidifies the polyvinyl alcohol on the recording layer while it is still wet, pressing the recording layer on a heated mirror surface while the recording layer is still wet and then drying so as to confer gloss to the recording layer surface, wherein this treatment solution contains a borate and a water-soluble magnesium salt.

It is preferred that the concentrations of the borate and water-soluble magnesium salt in the aforesaid treatment solution are respectively 0.4-6 wt % and 0.5-6 wt % in terms of anhydrides, and that the water-soluble magnesium salt is at least one salt selected from among magnesium chloride, magnesium sulfate and magnesium nitrate. The gloss of the recording layer is further enhanced by containing boric acid in the treatment solution.

### DESCRIPTION OF THE PREFERRED EMBODIMENTS

The air-permeable support used in this invention may be suitably selected from among those known in the art, but paper (coated paper or uncoated paper) is preferred. The raw material pulp for this paper may be a chemical pulp (bleached or unbleached kraft pulp from coniferous trees, bleached or unbleached kraft pulp from broad-leaved trees), mechanical pulp (groundwood pulp, thermomechanical pulp, chemithermomechanical pulp) or deinked pulp, any of which may be used alone, or blended together in a desired ratio. The pH of the paper may be acid, neutral or alkaline. The opacity of the paper can be increased by containing a filler in the paper, so a filler is preferably used. This filler may be suitably selected from among those known in the art such as hydrated silicic acid, white carbon, talc, kaolin, clay, calcium carbonate, titanium oxide or a synthetic resin filler.

The alumina contained in the recording layer of the inkjet recording medium of this invention is an aluminum oxide obtained by, for example, sintering aluminum hydroxide. Alumina is known to have many crystalline forms, such as α-alumina, β-alumina and γ-alumina. In this invention, in order to enhance scratch resistance, γ-alumina is particularly preferred.

The particle diameter and BET specific surface area of the alumina may be suitably selected as required, but the average particle diameter is preferably 1.0-4.0 μm and more preferably 1.5-3.3 μm. The average particle diameter of the alumina can be measured by laser diffraction or scattering techniques.

To the extent that it does not impair the effect of this invention, other pigments may also be blended such as silica, kaolin, talc, calcium carbonate, titanium dioxide, clay and zinc oxide.

The recording layer in this invention contains polyvinyl alcohol as a binder. By using polyvinyl alcohol, not only can the transparency of the recording layer be improved and a gloss approaching that of a silver halide photograph be obtained, but print density is also improved and the recorded image is clear. The improvement of print density is particularly marked when using dye inks.

To the extent that they do not interfere with the purpose of this invention, binders other than polyvinyl alcohol may also be blended, for example starches such as oxidized starch and esterified starch, cellulose derivatives such as carboxymethyl cellulose and hydroxyethylcellulose, polyvinyl pyrrolidone, casein, gelatin, soya bean protein, styrene-acrylic resin and its derivatives, styrene butadiene latex, acrylic emulsion, vinyl acetate emulsion, vinyl chloride emulsion, urethane emulsion, urea emulsion, or alkyd emulsions and derivatives thereof.

The blending amount of the binder in the recording layer is preferably 5 wt parts-30 wt parts, and more preferably 20 wt parts or less relative to 100 wt parts of pigment, but it is not particularly limited provided that the required recording layer strength can be obtained. If the blending amount of binder is too small, the recording layer strength tends to fall, and if it is too large, ink absorption properties tend to decrease.

Also, if the blending amount of polyvinyl alcohol is too small, it is difficult to obtain sheet gloss, so the blending amount of the polyvinyl alcohol in the binder component of the recording layer is preferably 30 wt % or more, and more preferably 50 wt % or more.

In this invention, after coating the recording layer on the support, a treatment solution which can solidify the polyvinyl alcohol in the recording layer (hereafter, solidifying solution) is applied. In this invention, the treatment solution having the function of solidifying the polyvinyl alcohol in this case is a treatment solution containing at least a borate and a water-soluble magnesium salt, but it preferably also contains boric acid. The water-soluble magnesium salt improves the folder storage properties of the inkjet recording medium described later, and is not intended to solidify the polyvinyl alcohol.

The borate used in this invention may for example be borax, an orthoborate, diborate, metaborate, pentaborate or octaborate. The borate is not particularly limited, but from the viewpoint of cost and ease of procurement, the use of borax is preferred. The concentration of borate in the treatment solution may be suitably adjusted depending on requirements, but it is preferably within the range of 0.5-4.5 wt % and more preferably within the range of 1-3.5 wt % in terms of anhydride. If the concentration of borate is too high, the strength of the recording layer increases but unevenness of gloss may occur so sheet gloss tends to decrease. On the other hand, if the concentration of borate is too low, the strength of the recording layer tends to decline.

It is preferable to mix the boric acid with the borate in the treatment solution to make it easier to adjust the solidification state of the polyvinyl alcohol, and easier to obtain an inkjet recording medium having satisfactory gloss. The total concentration of borate and boric acid is preferably within the range of 1-8 wt % after conversion to anhydrides.

It is particularly preferred that the blending ratio of borate and boric acid (borate/boric acid) in the treatment solution is 1/4-2/1 as weight ratio in terms of anhydrides. If the blending ratio of borate and boric acid is less than 1/4, the proportion of boric acid is too high, so solidification of the polyvinyl alcohol in the recording layer may be incomplete and partially-solidified recording layer may stick to the treatment solution roll, thus it may be impossible to obtain a satisfactory, wet recording layer. On the other hand, if the blending ratio of borate and boric acid exceeds 2/1, the solidified polyvinyl alcohol in the recording layer may be too hard, so that when the wet recording layer is pressed in contact with the heated mirror surface drum via a press roll, and dried, the gloss of the drum surface is not properly duplicated and it is difficult to obtain a satisfactory glossy surface.

In this invention, a water-soluble magnesium salt is contained in the aforesaid treatment solution. Various water-soluble magnesium salts can be used, but magnesium chloride, magnesium sulfate and magnesium nitrate are particularly preferred as they considerably improve the folder storage properties. Also, from the viewpoint of balance between inkjet recording suitability and folder storage properties, magnesium nitrate is most preferred. Two or more of these water-soluble magnesium salts may also be used in conjunction according to requirements.

The concentration of the water-soluble magnesium salt in the treatment solution is preferably 0.5-6 wt %, and more preferably 1-5 wt % in terms of anhydrides. If the concentration is too low, the enhancement of file storage properties are small, while if the concentration is too high, recording layer strength decreases and sheet gloss tends to decline.

A release agent may, if required, be added to the recording layer and solidifying solution of this invention. The melting point of the added release agent is preferably 90-150° C., but more preferably 95-120° C. Within the above range, the melting point of the release agent is almost identical to the surface temperature of the mirror finish, so the function of the release agent can be optimized.

The recording layer coating solution and solidifying solution used in this invention may, if required, contain suitable additives such as a pigment dispersant, water retaining agent, thickener, antifoaming agent, preservative, colorant, water resistant additive, wetting agent, fluorescent dye, ultraviolet absorption agent and cationic polymer electrolyte.

In this invention, it is preferred that the treatment solution (solidifying solution) having the function of solidifying the polyvinyl alcohol in the wet recording layer is applied immediately after coating the coating solution, and the wet recording layer is then pressed in contact with the heated mirror surface to confer gloss (e.g., solidification cast coating method). If the recording layer is dry when the treatment solution is applied (e.g., rewetting cast coating method) is difficult to transfer the mirror surface finish, and as surface roughness is increased, is difficult to obtain a gloss comparable to that of a silver halide photograph.

The method used to coat the recording layer on the support may be suitably selected from among methods which use coating devices known in the art such as a blade coater, air knife coater, roll coater, brush coater, kiss coater, squeeze coater, curtain coater, die coater, bar coater, gravure coater or comma roll coater. The solidifying solution can be applied by any method known in the art for application on a wet recording layer, e.g., a roll, spray or curtain.

The coating amount of the recording layer may be adjusted as desired provided that it coats the surface of the base paper and provides sufficient ink absorption properties, but from the viewpoint of both recording density and ink absorption properties, it is preferably 5-30 g/m² per side in terms of solids. If productivity is also taken into account, however, it is preferably 10-25 g/m² per side in terms of solids. If 30 g/m² is exceeded, the medium may not be properly released from the mirror surface, and the recording layer may stick to the mirror surface. If a large coating amount is required, an undercoat layer may be provided between the support and the recording layer.

### EXAMPLES

This invention will now be described in more detail with examples, but it should be understood that the invention is not to be construed as being limited in any way thereby. Also, unless otherwise specified, “parts” and “%” respectively refer to “wt parts” and “wt %”.

### Example 1

A base paper was produced from a pulp slurry, prepared by adding 10 wt parts of talc, 1.0 wt parts of aluminum sulfate, 0.1 wt parts of a synthetic sizing agent and 0.02 wt parts of a retention aid to pulp consisting of 100 parts of bleached broad-leaved kraft pulp (L-BKP) having a beating degree of 285 ml, using a paper machine. Starch was coated on both sides of the support by a gate roll to an amount of 1.5 g/m² per side, and the following solution A was then coated on one side as an undercoat using a blade coater to give a dry coating weight of 7 g/m², so as to obtain an inkjet recording medium base paper having a weighting of 190 g/m².

Coating Solution A:

5 parts of SB latex (LX438C: commercial name, Sumitomo Chemical Co., Ltd.), 20 parts of polyvinyl alcohol (PVA-117: commercial name, Kuraray Co., Ltd.) and 5 parts of a sizing agent (Polymalon 360: commercial name, Arakawa Chemical Industries Ltd.) were blended with 100 parts of synthetic silica (Fineseal X-37: commercial name, Tokuyama Corp.), so as to prepare a coating solution having a concentration of 20%.

The following coating solution B was coated on the undercoat layer of the base paper obtained above using a roll coater to give a dry coating weight of 20 g/m². The recording layer was solidified using the following solidifying solution C while the recording layer was still wet, and pressed in contact with the mirror surface of a drum heated to 105° C. by a press roll to duplicate the mirror surface and thus obtain an inkjet recording medium of 210 g/m². The drying time of the recording layer was 20 seconds.

Coating Solution B:

50 parts of high purity γ-alumina (UA-5605: commercial name, Showa Denko KK.) and 50 parts of high purity γ-alumina (AKP-GO15: commercial name, Sumitomo Chemical Co., Ltd.) as pigment, 13 parts of polyvinyl alcohol (PVA-224: commercial name, Kuraray Co., Ltd.) as binder, and 0.2 parts of an antifoaming agent, were blended together so as to prepare a coating solution having a concentration of 28%.

Solidifying Solution C:

1.7% (as anhydride) of borax together with 5% boric acid, 3% (as anhydride) of magnesium nitrate hexahydrate and 0.2% of a release agent (FL-48C: commercial name, Toho Chemical Industry Co., Ltd.) were blended together to prepare a solidifying solution having a concentration of 9.9%.

### Example 2

An inkjet recording medium was obtained in an identical way to that described in Example 1, except that the blending concentration of magnesium nitrate hexahydrate (as anhydride) in solidifying solution C was 1%.

### Example 3

An inkjet recording medium was obtained in an identical way to that described in Example 1, except that the blending concentration of magnesium nitrate hexahydrate (as anhydride) in solidifying solution C was 6%.

### Example 4

An inkjet recording medium was obtained in an identical way to that described in Example 1, except that the blending concentration of magnesium nitrate hexahydrate (as anhydride) in solidifying solution C was 9%.

### Example 5

An inkjet recording medium was obtained in an identical way to that described in Example 1, except that instead of magnesium nitrate hexahydrate in solidifying solution C, 3% of magnesium nitrate heptahydrate (as anhydride) was blended.

### Example 6

An inkjet recording medium was obtained in an identical way to that described in Example 1, except that instead of magnesium nitrate hexahydrate in solidifying solution C, 3% of magnesium chloride (as anhydride) was blended.

### Example 7

An inkjet recording medium was obtained in an identical way to that described in Example 1, except that instead of magnesium nitrate hexahydrate in solidifying solution C, 3% of magnesium thiosulfate hexahydrate (as anhydride) was blended.

### Example 8

An inkjet recording medium was obtained in an identical way to that described in Example 1, except that instead of magnesium nitrate hexahydrate in solidifying solution C, 3% of magnesium acetate tetrahydrate (as anhydride) was blended.

### Example 9

An inkjet recording medium was obtained in an identical way to that described in Example 1, except that the blending concentration of borax (as anhydride) used in solidifying solution C was 0.4%.

### Example 10

An inkjet recording medium was obtained in an identical way to that described in Example 1, except that the blending concentration of borax (as anhydride) used in solidifying solution C was 4%.

### Comparative Example 1

An inkjet recording medium was obtained in an identical way to that described in Example 1, except that instead of magnesium nitrate hexahydrate in solidifying solution C, 3% of calcium nitrate tetrahydrate (as anhydride) was blended.

### Comparative Example 2

An inkjet recording medium was obtained in an identical way to that described in Example 1, except that instead of magnesium nitrate hexahydrate in solidifying solution C, 3% of calcium nitrate dihydrate (as anhydride) was blended.

### Comparative Example 3

An inkjet recording medium was obtained in an identical way to that described in Example 1, except that instead of magnesium nitrate hexahydrate in solidifying solution C, 3% of barium chloride dehydrate (as anhydride) was blended.

### Comparative Example 4

An inkjet recording medium was obtained in an identical way to that described in Example 1, except that the blending concentration of magnesium nitrate hexahydrate in solidifying solution C was 0%.

### Comparative Example 5

Instead of blending magnesium nitrate hexahydrate with solidifying solution C, 3% (as anhydride) was blended with coating solution B. This made the coating solution B very tacky, so the recording layer could not be coated uniformly, and an inkjet recording medium could not be manufactured.

### Comparative Example 6

An inkjet recording medium was obtained in an identical way to that described in Example 1, except that the blending concentration of borax in solidifying solution C was 0%.

For the inkjet recording media obtained in Examples 1-10, and the inkjet recording medium obtained in Comparative Examples 1-4 and 6, an inkjet recording test, gloss evaluation, recording layer strength evaluation and folder storage property evaluation were performed by the following methods. The results are summarized in Table 1. For each evaluation item, the symbol Δ or better means that the recording medium can be used without problem.

(1) Inkjet Recording Test

A predetermined fill and image pattern were recorded using an inkjet printer (PM-800C: commercial name, Seiko Epson Ltd.) and evaluated according to the following criteria:

a: Print Density

The density of black, cyan, magenta and yellow fill patterns was measured with a Macbeth densitometer (RD 915, Macbeth), and the sum of measured values was taken as the print density.

b: Ink Absorption Properties (Bleeding)

A pattern having adjacent fill images of red (mixture of magenta and yellow) and green (mixture of cyan and yellow) were printed, and the smudging (bleeding) at the boundary was visually evaluated according to the following criteria. Smudging (bleeding) at the boundary between red and green appears black, so a more rigorous evaluation can be performed.
⊚: No bleeding observed at all at boundary
◯: Almost no bleeding observed at boundary
Δ: Slight bleeding observed at boundary
X: Serious bleeding observed at boundary
   (2) Sheet Gloss

The 20° mirror surface gloss of the Sheet measured according to the method described in JIS Z8741 was taken as the sheet gloss. If the sheet gloss is 15% or more, the medium has the gloss of a silver halide photograph.

(3) Recording Layer Strength

The writability when the recording layer was written on with a ball-point pen, was visually evaluated:
⊚: The recording layer is not scratched at all by the ball-point pen, and writability is excellent
◯: The recording layer is hardly scratched by the ball-point pen, and writability is good
Δ: The recording layer is scratched by the ball-point pen, but there is no problem as regards readability of written characters
X: The recording layer is badly scratched by the ball-point pen, and it is difficult to read written characters.
   (4) Folder Storage Properties

A sample was inserted in a clear folder (CL-A420: commercial name, Mitsubishi Pencils Ltd.) allowing 3 cm to protrude, and heated at 70° C. for 1 week. The color difference (ΔE*) after this treatment was measured based on the color before treatment. If the color difference (ΔE*) was 3.0 or less, it was determined that there was no problem as regards folder storage properties.

TABLE 1

| | Composition of solidifying solution C | | | | | | | | |
|---|---|---|---|---|---|---|---|---|---|
| | Borax | Boric acid | Water-soluble metal salt | | | Ink | | Recording | Color |
| | Amount of | Amount of | | Amount of | Print | absorption | Sheet gloss | Layer | difference |
| | addition | addition | Kind | addition | density | properties | (%) | strength | (ΔE*) |
| Example1 | 1.7 | 5 | Mg(NO₃)₂ | 3 | 8.03 | ⊚ | 25 | ◯ | 1.6 |
| Example2 | 1.7 | 5 | Mg(NO₃)₂ | 1 | 8.04 | ⊚ | 28 | ◯ | 2.6 |
| Example3 | 1.7 | 5 | Mg(NO₃)₂ | 6 | 8.00 | ◯ | 22 | ◯ | 1.4 |
| Example4 | 1.7 | 5 | Mg(NO₃)₂ | 9 | 7.92 | Δ | 15 | Δ | 1.3 |
| Example5 | 1.7 | 5 | MgSO₄ | 3 | 8.00 | ⊚ | 24 | ◯ | 2.3 |
| Example6 | 1.7 | 5 | MgCl₂ | 3 | 7.98 | Δ | 22 | ◯ | 1.8 |
| Example7 | 1.7 | 5 | MgS₂O₃ | 3 | 7.99 | ⊚ | 20 | ◯ | 2.6 |
| Example8 | 1.7 | 5 | Mg(CH₃COO)₂ | 3 | 7.95 | ◯ | 20 | ◯ | 2.9 |
| Example9 | 0.4 | 5 | Mg(NO₃)₂ | 3 | 8.04 | ⊚ | 27 | Δ | 1.5 |
| Example10 | 4 | 5 | Mg(NO₃)₂ | 3 | 8.02 | ⊚ | 18 | ⊚ | 2.4 |
| Comparative | 1.7 | 5 | Ca(NO₃)₂ | 3 | 7.99 | ⊚ | 19 | ◯ | 3.6 |
| ex.1 | | | | | | | | | |
| Comparative | 1.7 | 5 | CaSO₄ | 3 | 7.96 | ◯ | 20 | ◯ | 4.2 |
| ex.2 | | | | | | | | | |
| Comparative | 1.7 | 5 | BaCl₂ | 3 | 7.94 | Δ | 17 | ◯ | 4.5 |
| ex.3 | | | | | | | | | |
| Comparative | 1.7 | 5 | Mg(NO₃)₂ | 0 | 8.05 | ⊚ | 30 | ◯ | 4.9 |
| ex.4 | | | | | | | | | |
| Comparative | 1.7 | 5 | — | — | 3 parts of Mg(NO₃)₂ was blended with coating solution B. | | | | |
| ex.5 | | | | | This made the coating solutionB very tacky, so the | | | | |
| | | | | | recording layer could not be coated uniformly. | | | | |
| Comparative | 0 | 5 | Mg(NO₃)₂ | 3 | 8.06 | ⊚ | 29 | X | 1.2 |
| ex.6 | | | | | | | | | |

As is clear from Table 1, well-balanced, satisfactory results were obtained for the inkjet recording media of this invention obtained in Examples 1-10 as regards printing suitability, sheet gloss, recording layer strength and folder storage properties. On the other hand, in Comparative Examples 1-3 where the water-soluble metal salt was not a magnesium salt, and in Comparative Example 4 where a water-soluble magnesium salt was not blended, there was a pronounced yellowing of the white paper after storing in a folder, and the quality of the inkjet recording medium was unsatisfactory. In Comparative Example 6 where a borate was not blended with the solidifying solution C, printing suitability, sheet gloss and folder storage properties were relatively good, but recording layer strength seriously declined, and the quality of the inkjet recording medium was found to be unsatisfactory.

Usability for Industry

The inkjet recording medium of this invention has a gloss comparable to that of a silver halide photograph, has a strong recording layer without yellowing when stored in a folder. It also offers a printed material having excellent ink absorption properties together with high print density realizing high quality inkjet recording, therefore, the present invention is quite useful for industry.

1. An inkjet recording medium characterized by that formed by providing a recording layer comprising alumina and polyvinyl alcohol on a support having air permeability, coating a treatment solution which solidifies said polyvinyl alcohol on the recording layer while it is still wet, pressing said recording layer on a heated mirror surface while said recording layer is still wet and drying so as to confer gloss to said recording layer surface, wherein said treatment solution contains a borate and a water-soluble magnesium salt.

2. The inkjet recording medium according to claim 1, wherein the concentrations of said borate and water-soluble magnesium salt are respectively 0.4-6 wt % and 0.5-6 wt % in terms of anhydrides.

3. The inkjet recording medium according to claim 1, wherein the water-soluble magnesium salt in said treatment solution is at least one salt selected from among magnesium chloride, magnesium sulfate and magnesium nitrate.

4. The inkjet recording medium according to claim 1, wherein said treatment solution contains boric acid.

5. The inkjet recording medium according to claim 1, wherein a ratio of binder and pigment in the recording layer is that the binder is 5 wt parts-30 wt parts relative to 100 wt parts of pigment.

6. The inkjet recording medium according to claim 5, wherein said amount of binder in the recording layer is more than 30 wt %.

7. The inkjet recording medium according to claim 1, wherein said treatment solution further contains boric acid.

8. The inkjet recording medium according to claim 1, wherein said borate is borax.

9. The inkjet recording medium according to claim 1, wherein a concentration of the borate in said treatment solution is 0.5˜4.5 wt % in terms of anhydride.

10. The inkjet recording medium according to claim 7, wherein a weight ratio of borate and boric acid (borate/boric acid) in said treatment solution is 1/4˜2/1 in terms of anhydride.

11. The inkjet recording medium according to claim 1, wherein the water-soluble magnesium salt is at least one salt selected from among magnesium chloride, magnesium sulfate and magnesium nitrate.

12. The inkjet recording medium according to claim 1, wherein the concentration of the water-soluble magnesium salt is 0.5-6 wt % in terms of anhydrides.

13. The inkjet recording medium according to claim 1, wherein a release agent is further contained in the recording layer and/or the treating solution.

14. The inkjet recording medium according to claim 13, wherein a melting point of said release agent is 90˜150° C.

15. The inkjet recording medium according to claim 1, wherein a coating amount of the recording layer is 5˜30 g/m².

16. A method of manufacturing an inkjet recording medium characterized by providing a recording layer comprising alumina and polyvinyl alcohol on a support having air permeability, coating a treatment solution which contains a borate and a water-soluble magnesium salt on the recording layer while it is still wet, pressing said recording layer on a heated mirror surface while said recording layer is still wet and drying so as to confer gloss to said recording layer surface.

17. The method of manufacturing an inkjet recording medium according to claim 16, wherein said treatment solution further contains boric acid.
